(19) United States
(12) Patent Application Publication
(10) Pub. No.: US 2015/0185387 A1
(43) Pub. Date: Jul. 2, 2015

(54) POLARIZATION FILM, VISIBLE LATENT IMAGE ARTICLE, AND MANUFACTURING METHOD THEREOF

(71) Applicant: FUJIFILM CORPORATION, Tokyo (JP)

(72) Inventors: Ichirou AMIMORI, Kanagawa (JP); Hideki KANEIWA, Kanagawa (JP)

(73) Assignee: FUJIFILM CORPORATION, Tokyo (JP)

(21) Appl. No.: 14/635,557

(22) Filed: Mar. 2, 2015

Related U.S. Application Data
(63) Continuation of application No. PCT/JP2013/072240, filed on Aug. 21, 2013.

(30) Foreign Application Priority Data
Sep. 27, 2012 (JP) 2012-215056

(51) Int. Cl. G02B 5/30; B32B 37/10; G09F 3/02

(52) U.S. Cl. CPC G02B 5/3083; G02B 5/3033; G09F 3/02; G02B 5/3016; B32B 37/10; B32B 2307/42

(57) ABSTRACT

There is provided a polarization film, a visible latent image article, and a manufacturing method thereof enabling a latent image using a birefringent property to be provided in a visualized state. A polarization film includes a polarization layer transmitting a specific linear polarization component, a circular polarization component, or an elliptical polarization component, and an adhesive layer, a tensile modulus of elasticity E of the polarization film is 0.01 GPa to 7.8 GPa, and a thickness h of the polarization film is 60 μm to 300 μm, and in a visible latent image article which includes the polarization film and the article having a birefringent pattern, the polarization film is peelably affixed to the article having a birefringent pattern through the adhesive layer, and thus a latent image due to the birefringent pattern is visible by the polarization film.

### CROSS-REFERENCE TO RELATED APPLICATIONS

This application is a Continuation of PCT International Application No. PCT/JP2013/072240 filed on Aug. 21, 2013, which claims priority under 35 U.S.C §119(a) to Japanese Patent Application No. 2012-215056 filed on Sep. 27, 2012. Each of the above application(s) is hereby expressly incorporated by reference, in its entirety, into the present application.

### BACKGROUND OF THE INVENTION

1. Field of the Invention

The present invention relates to a polarization, visible latent image article, and manufacturing method thereof. More specifically, the present invention relates to an article having a birefringent pattern which is able to prevent forgery and in which a latent image due to the birefringent pattern of the article is visualized by a polarization film, the polarization film, and a manufacturing method thereof.

2. Description of the Related Art

An article having a birefringent pattern includes a latent image which is invisible in a light source not having a polarization property, but is able to be visualized by a polarization filter. A manufacturing method of an example of the article having a birefringent pattern is disclosed in JP2009-69793A and JP2010-113249A, and it is proposed that the article is applied to prevent forgery.

By using a film having a birefringent pattern, the birefringent pattern is disposed on a part of a front surface of the article such as a ticket or a bottle, and thus the article is able to simply have a forgery preventing function. However, the forgery preventing function is not recognized by a latent image which is not visualized, and thus it is anticipated that an effect of suppressing forgery in advance will decrease.

In JP3436948B, a technology in which an information display medium including an information record by using a polarization property material is contained in a containing portion including a polarization filter, and the information visualized by the polarization filter is provided in a state of being visualized is disclosed.

### SUMMARY OF THE INVENTION

An object of the present invention is to provide means for enabling a latent image using a birefringent property to be provided in a visualized state. As described in JP3436948B, the article having a birefringent pattern is provided by being integrated with the polarization plate in a separable shape, and thus the latent image is able to be provided by being visualized and then is able to be used as an invisible latent image. The present inventors have conceived an idea of using a polarization filter by peelably affixing the polarization filter to a latent image portion in the shape of a label as such means, and have conducted intensive studies on the basis of this idea, and thus have completed the present invention.

That is, the present invention provides the following [1] to [12].

[1] A polarization film which is peelably affixed to an article having a birefringent pattern and visualizes a latent image due to the birefringent pattern, which polarization film includes a polarization layer transmitting a specific linear polarization component, a circular polarization component, or an elliptical polarization component, and an adhesive layer, wherein a tensile modulus of elasticity E of the polarization film is 0.01 GPa to 7.8 GPa, and a thickness h of the polarization film is 60 μm to 300 μm.

[2] The polarization film according to [1], in which the adhesive layer is disposed such that the adhesive layer is not able to be adhered to the article having a birefringent pattern in at least a part of a region in contact with an outer circumference of a polarization filter.

[3] A visible latent image article including the polarization film and the article having a birefringent pattern according to [1] or [2], in which the polarization film is peelably affixed to the article having a birefringent pattern through the adhesive layer, and thus a latent image due to the birefringent pattern is visible by the polarization film.

[4] The visible latent image article according to [3], in which a peeling force A between the polarization film and the article having a birefringent pattern is 1.0 N/m to 500 N/m.

[5] The visible latent image article according to [4], in which an elastic modulus E and a thickness h of the polarization film, and the peeling force A have the following relationship: h³E/2.6<100×A.

[6] The visible latent image article according to any one of [3] to [5], in which the article having a birefringent pattern includes an additional adhesive layer on a side opposite to a surface in contact with the polarization film.

[7] The visible latent image article according to [6], in which a release sheet is disposed on a side opposite to the polarization film on the basis of the additional adhesive layer.

[8] The visible latent image article according to [7], in which a shape of the polarization film and a shape of the article having a birefringent pattern are approximately identical to each other, and when a peeling force between the polarization film and the article having a birefringent pattern is B (N/m), and a peeling force between the article having a birefringent pattern and the release sheet is C (N/m), B>C is satisfied.

[9] The visible latent image article according to [7], in which the polarization film is affixed to only a part of a visible side front surface of the article having a birefringent pattern, and when a peeling force between the polarization film and the article having a birefringent pattern is B (N/m), and a peeling force between the article having a birefringent pattern and the release sheet is C (N/m), B≦C is satisfied.

[10] The visible latent image article according to any one of [3] to [9], in which the polarization layer is a polarization layer transmitting a linear polarization component or an elliptical polarization component, and an angle between a maximum absorption axis of the polarization layer and a slow axis of a region of at least a part of the article having a birefringent pattern is 30 degrees to 60 degrees.

[11] The visible latent image article according to any one of [3] to [10], in which the article having a birefringent pattern includes a patterned optical anisotropic layer formed of a composition including a liquid crystalline compound.

[12] A manufacturing method of the visible latent image article according to [11] including: rubbing an alignment layer on a roll-like supporter in a direction having an angle of 30 degrees to 60 degrees with respect to a longitudinal direction of the supporter; obtaining a roll-like laminated body by forming the patterned optical anisotropic layer on the rubbed alignment layer; and affixing the polarization film which is wound in the shape of a roll having a direction of an absorption axis of the laminated body and the polarization layer as a longitudinal direction by roll-to-roll processing.

According to the present invention, means for enabling a latent image using a birefringent property to be provided in a visualized state is provided.

### BRIEF DESCRIPTION OF THE DRAWINGS

FIG. 1 is a diagram illustrating a pattern of pattern exposure performed in Example 2.

FIG. 2 is an enlarged diagram of a pattern which is observed through a polarization plate on an article M-2 having a birefringent pattern prepared in Example 2.

FIG. 3 is a diagram illustrating an example in which a visualized birefringent pattern label PL-1 prepared in Example 3 is peeled off from a release sheet and is affixed to a voucher.

FIG. 4 is a diagram illustrating an example in which the visualized birefringent pattern label PL-1 prepared in Example 3 is peeled off from the release sheet and is affixed to the voucher.

FIG. 5 is a diagram illustrating an example in which a visualized birefringent pattern label PL-6 prepared in Example 5 is peeled off from the release sheet and is affixed to the voucher.

FIG. 6 is a diagram illustrating an example in which a part of a visualized birefringent pattern label PL-7 prepared in Example 6 is peeled off from the release sheet and is affixed to the voucher.

FIG. 7 is a diagram illustrating an example in which a part of the visualized birefringent pattern label PL-7 prepared in Example 6 is peeled off from the release sheet and is affixed to the voucher.

FIG. 8 is a diagram illustrating a pattern of pattern exposure performed in Example 8.

FIG. 9 is an enlarged diagram of a pattern which is observed through a polarization plate on a semi-transmitting article M-4 having a birefringent pattern prepared in Example 8.

FIG. 10 is a diagram illustrating an example in which a visualized semi-transmitting birefringent pattern label PL-9 prepared in Example 8 is peeled off from the release sheet and is affixed to a plastic card of which a ground is subjected to printing.

FIG. 11 is a diagram illustrating a pattern of pattern exposure performed in Example 9.

FIG. 12 is an enlarged diagram of a pattern which is observed through a polarization plate on a roll-like article M-6 having a birefringent pattern prepared in Example 9.

FIG. 13 is a diagram illustrating a birefringent pattern label integrated body M-7 prepared in Example 10 which discretely includes a label on the release sheet.

FIG. 14 is a diagram illustrating a visualized birefringent pattern label integrated body PL-10 prepared in Example 10.

FIG. 15 is a diagram illustrating a visualized birefringent pattern label integrated body PL-11 prepared in Example 11.

### DESCRIPTION OF THE PREFERRED EMBODIMENTS

Hereinafter, the present invention will be described in detail.

Furthermore, in this specification, “to” is used in the sense of including numerical values before and after “to” as a lower limit value and an upper limit value.

In this specification, Re represents retardation (a phase difference). Re is able to be measured by using a spectrum phase difference method in which a transmissive or reflective spectral spectrum is converted into a phase difference using a method disclosed in Journal of Optical Society of America, vol. 39, p. 791-794 (1949) or JP2008-256590A. The literature described above discloses a measurement method using a transmissive spectrum, and in particular, in a case of a reflective spectrum, light passes through an optical anisotropic layer two times, and thus half of the phase difference converted from the reflective spectrum is able to be a phase difference of the optical anisotropic layer. Unless it is particularly designated, the retardation (Re) indicates front surface retardation. Re (λ) uses light having a wavelength of λ nm as a measurement light. In this specification, Re indicates retardation measured by each wavelength of 611±5 nm, 545±5 nm, and 435±5 nm with respect to R, G, and B, and unless there is description about a color, Re indicates retardation measured by a wavelength of 545±5 nm.

In this specification, “substantially” with respect to an angle indicates that an error between the angle and an exact angle is within a range less than ±5°. Further, the error between the angle and the exact angle is preferably less than 4°, and is more preferably less than 3°. “Substantially” with respect to retardation indicates that the retardation has a difference within ±5%. Further, “retardation is substantially 0” indicates that the retardation is less than or equal to 5 nm. In addition, unless it is particularly described, a measurement wavelength of a refractive index indicates an arbitrary wavelength in a visible light region. Furthermore, in this specification, “visible light” indicates light having a wavelength of 400 nm to 700 nm.

[Polarization Film]

In this specification, a polarization film indicates a film including a polarization layer and an adhesive layer. A polarization film of the present invention is peelably affixed to an article having a birefringent pattern, and is used for visualizing a latent image due to the birefringent pattern. In this specification, “peelably” indicates that the polarization film is able to be peeled off after being adhered without influencing the article having a birefringent pattern. The polarization film after being peeled off may or may not be reused. In addition, the polarization film may be affixed to an entire surface of the birefringent pattern of the article having a birefringent pattern, or may be affixed to only a part thereof. When it is necessary that the affixed polarization film be subjected to authenticity determination without being peeled off (for example, when the affixed polarization film is subjected to authenticity determination in a retail shop without being peeled off, and then a customer tries to peel off the polarization film and perform the authenticity determination), it is preferable that the polarization film be affixed to a part of the birefringent pattern.

In this specification, the article in which the polarization film is peelably affixed to the article having a birefringent pattern, and the latent image due to the birefringent pattern is visualized is referred to as a “visible latent image article”. The visible latent image article, for example, is able to be prepared as a label. By preparing the visible latent image article as the label, the visible latent image article is able to be used by being affixed to a cylindrical curved surface in a bottle or the like. In addition, an aspect in which the polarization film is affixed to the article having a birefringent pattern in the shape having the cylindrical curved surface such as a bottle, and the visible latent image article is prepared is considered. In this usage, a problem in that when a peeling force between the polarization film and the article having a birefringent pattern is excessively strong, the polarization film is not able to be peeled off, and when the peeling force is excessively weak, the polarization film is folded back due to rigidity of the polarization layer itself, and thus the polarization film is naturally peeled off and falls off occurs. The present inventors have conducted intensive studies, and thus have found a suitable range of a film thickness and a tensile modulus of elasticity.

It is preferable that the polarization film be thick in order to have a sufficient self-supporting property, and it is preferable that the polarization film be thin in order not to be peeled off due to rigidity of the polarization layer itself when the polarization film is affixed to the curved surface. For this reason, the thickness of the polarization film may be greater than or equal to 60 μm, greater than or equal to 80 μm, greater than or equal to 90 μm, or greater than or equal to 130 μm, and may be less than or equal to 300 μm, less than or equal to 250 μm, or less than or equal to 210 μm.

It is preferable that an elastic modulus of the polarization film increase in order to have a sufficient self-supporting property, and it is preferable that the elastic modulus of the polarization film decrease in order not to be peeled off due to the rigidity of the polarization layer itself when the polarization film is affixed to the curved surface. For this reason, the elastic modulus of the polarization film may be greater than or equal to 0.01 GPa, greater than or equal to 0.02 GPa, or greater than or equal to 0.03 GPa, and may be less than or equal to 7.0 GPa, less than or equal to 6.5 GPa, or less than or equal to 6.0 GPa. As an especially preferable range, a range of 4.0 GPa to 6.0 GPa is included.

The elastic modulus is able to be obtained by measuring a sample having a length of 100 mm and a width of 10 mm at an initial sample length of 50 mm and a tensile speed of 20 mm/min according to a standard of ISO1184-1983.

In addition, it is preferable that light transmissivity of the polarization film be high, and the transmissivity is preferably greater than or equal to 30% in 550 nm, the transmissivity is more preferably greater than or equal to 40%, and the transmissivity is especially preferably greater than or equal to 45%.

[Polarization Layer]

The polarization layer of the polarization film according to the present invention may be a linear polarization film, a circular polarization film, or an elliptical polarization film.

As the polarization layer, a known suitable polarization layer is able to be used, and a type of polarization layer is not particularly limited. As a specific example of the polarization layer, an absorptive polarization layer in which a film including high molecules doped with iodine or a dichroism dye is uniaxially extended, a reflective polarization layer in which two types of polymer layers having a different birefringent property are alternately laminated at a film thickness of 20 nm to 300 nm and are uniaxially extended, a circular polarization selective reflection polarization layer of a cholesteric liquid crystal, and the like are included. Further, at least one surface of the polarization layers may have uniform retardation thickness less than or equal to 300 nm, or a substantially isotropic film having retardation thickness less than or equal to 20 nm may be affixed. A thickness of the polarization layer including the affixed film is 50 μm to 250 μm, is preferably 60 μm to 220 μm, and is more preferably approximately 70 μm to 180 μm. An elastic modulus of the polarization layer is preferably 0.01 GPa to 10.0 GPa, is more preferably 0.02 GPa to 8.5 GPa, and is especially preferably 0.03 GPa to 8.0 GPa.

It is preferable that light transmissivity of the polarization layer be high, and the transmissivity is preferably greater than or equal to 30% in 550 nm, the transmissivity is more preferable greater than or equal to 40%, and the transmissivity is especially preferable greater than or equal to 45%. A scattering layer having concavities and convexities may be disposed in an uppermost layer on an observer side of the polarization layer.

[Adhesive Layer]

The adhesive layer may impart a peeling force of 1.0 N/m to 500 N/m to the polarization film when the polarization film is adhered to the article having a birefringent pattern, and the peeling force of 2.0 N/m to 400 N/m is preferably imparted, and the peeling force of 5.0 N/m to 300 N/m is more preferably imparted.

Furthermore, a value of the peeling force described above is based on JISZ0237, and is based on a value measured in a 180° peeling condition.

Specific examples of the adhesive layer are not particularly limited, and include a rubber-based adhesive agent, an acrylic-based adhesive agent, a silicone-based adhesive agent, a urethane-based adhesive agent, a vinyl alkyl ether-based adhesive agent, a polyvinyl alcohol-based adhesive agent, a polyvinyl pyrrolidone-based adhesive agent, a polyacrylamide-based adhesive agent, a cellulose-based adhesive agent, and the like.

As the adhesive agent used for the adhesive layer, an adhesive agent having excellent optical transparency, suitable adhesion properties of wettability, aggregability, and adhesiveness, excellent weather resistance or heat resistance, and the like are preferable. As the adhesive agent, an acrylic-based adhesive agent is especially preferable.

In general, the adhesive layer is disposed by applying and drying a solution of the adhesive agent. The solution of the adhesive agent, for example, is prepared by dissolving or dispersing the composition described above in a solvent formed of a single substance or a mixture of a suitable solvent such as toluene or ethyl acetate as a solution of approximately 10 mass % to 40 mass %. As a coating method, a roll coating method such as reverse coating and gravure coating, a spin coating method, a screen coating method, a fountain coating method, a dipping method, a spray method, and the like are able to be adopted. The adhesive layer may be formed by applying the solution of the adhesive agent on the polarization layer or on the film affixed to the polarization layer, and by drying the solution, and an adhesive layer in which the solution of the adhesive agent is applied on a release sheet and is dried may be used by being transferred.

A film thickness of the adhesive layer is 5 μm to 100 μm, is preferably 10 μm to 80 μm, and is more preferably approximately 20 μm to 50 μm.

It is preferable that light transmissivity of the adhesive layer be high, and the transmissivity is preferably greater than or equal to 70% in 550 nm, the transmissivity is more preferably greater than or equal to 80%, and the transmissivity is especially preferably greater than or equal to 90%.

The adhesive layer may be disposed such that the adhesive layer is not able to be adhered to the article having a birefringent pattern in at least a part of a region in contact with an outer circumference of the polarization film. As a method for realizing the above-described configuration, a method in which a layer forming the adhesive layer only in a part of an area of the polarization film and blocking adhesion of the adhesive layer with respect to a part of an area of a front surface of the adhesive layer (in this specification, referred to as “glue killing”) is disposed, and the like are included.

The method of laminating the glue killing on the front surface of the adhesive layer is not particularly limited. The glue killing, for example, may be performed by usual letterpress printing or intaglio printing, lithographic printing, or the like. A glue killing portion blocks the adhesion between the article having a birefringent pattern and the polarization film, and does not contribute to the adhesion therebetween.

As an example of an ink used for the glue killing, a UV ink (an ultraviolet curable ink), an oxidation polymerization ink, an electron beam curable ink, an oil-based ink, a water-soluble ink, and the like are included.

A pattern laminated as the glue killing is not particularly limited. Here, it is preferable that at least a part of the glue killing be in contact with the outer circumference of the polarization film.

An area occupied by the glue killing is preferably 3% to 80% with respect to an area of the adhesive layer, and is more preferably 5% to 60%. This is because when the area occupied by the glue killing is less than or equal to 3%, an effect of easily peeling off a polarization filter is insufficient, and when the area occupied by the glue killing is greater than or equal to 80%, an adhesive force decreases, or the polarization film is peeled off at an unintended stage.

[Latent Image]

In this specification, the latent image indicates a latent image using a birefringent property, and indicates an image which is invisible in a light source not having a polarization property, but is able to be visualized by the polarization film. In the present invention, the image which is able to be visualized by the polarization film may be obtained by a birefringent pattern.

[Definition of Birefringent Pattern]

The birefringent pattern broadly indicates a pattern in which two or more regions having a different birefringent property are arranged in a two-dimensional surface or are three-dimensionally arranged, and are drawn. Furthermore, in particular, in the two-dimensional surface, the birefringent property is defined by two parameters of a direction of a slow axis and magnitude of the retardation in the region at which the refractive index is maximized. For example, an in-plane alignment defect or an inclined distribution of a liquid crystal in a thickness direction in a phase difference film or the like formed of a liquid crystalline compound is broadly the birefringent pattern, but it is preferable to be narrowly defined as a birefringent pattern in which a birefringent property is intendedly controlled and patterned on the basis of a design or the like determined in advance. Unless it is particularly described, the birefringent pattern may be disposed over a plurality of layers, and boundaries of the pattern of the plurality of layers may be identical to each other or may be different from each other.

[Article having Birefringent Pattern]

In this specification, the “article having a birefringent pattern” indicates an article including two or more regions having a different birefringent property. The article having a birefringent pattern, for example, may include a patterned optical anisotropic layer. The article having a birefringent pattern may include various functional layers in a shape where the article is laminated with the patterned optical anisotropic layer in addition to the patterned optical anisotropic layer. The patterned optical anisotropic layer may be directly disposed on the article or may be disposed on the article through other functional layers or the like, and the patterned optical anisotropic layer disposed on a film-like supporter may be affixed to the article through the adhesive layer or the like which is disposed on a side of the supporter opposite to the patterned optical anisotropic layer. Furthermore, a portion below the adhesive layer when the patterned optical anisotropic layer is affixed through the adhesive layer is referred to as an “adherend” in this specification. In addition, for example, when the patterned optical anisotropic layer in the shape of a label including the adhesive layer is affixed to a front surface of the bottle, all of the label disposed on an release paper, the label at the time of being peeled off from the release paper, and the bottle affixed with the label correspond to the article having a birefringent pattern according to the present invention.

The article having a birefringent pattern and a preparing method thereof is not particularly limited, and is able to refer to JP2009-69793A, JP2010-113249A, and JP2011-203636A. An aspect using a birefringent pattern transfer foil is able to refer to the disclosure of JP2010-113249A and JP2012-113000A.

[Patterned Optical Anisotropic Layer]

As described in the literature, the patterned optical anisotropic layer may be formed of a composition including a liquid crystalline compound having at least one reactive group. For example, the patterned optical anisotropic layer is prepared from an optical anisotropic layer in which a solution including the liquid crystalline compound having at least one reactive group is applied on the supporter or an alignment layer disposed on the supporter, and a liquid crystal phase is formed, then is subjected to heating or light irradiation, and thus is polymerized and fixed. A thickness of the patterned optical anisotropic layer is preferably 0.1 μm to 20 μm, and more preferably 0.5 μm to 10 μm.

[Slow Axis of Patterned Optical Anisotropic Layer and Absorption Axis of Polarization Layer]

When the polarization filter is affixed to the article having a birefringent pattern, according to a directional relationship thereof, a difference occurs in visibility of the latent image. Specifically, when the polarization film is affixed in a shape where an angle between an absorption axis of the polarization layer and the slow axis of the article having a birefringent pattern is 30 degrees to 60 degrees, visibility of the latent image is excellent, and thus it is preferable.

[Functional Layer of Article Having Birefringent Pattern]

The article having a birefringent pattern may include a supporter, an alignment layer, a reflective layer, a print layer, a release layer, an additional adhesive layer, and the like in addition to the patterned optical anisotropic layer. In addition, the visible latent image article is obtained by affixing the polarization film to the article having a birefringent pattern, and thus similarly, may include a supporter, an alignment layer, a reflective layer, a print layer, a release layer, an additional adhesive layer, and the like.

[Supporter]

The supporter is not particularly limited insofar as it is able to support the patterned optical anisotropic layer and may be a rigid supporter or a flexible supporter, and the flexible supporter is preferable in terms of easy handling. The rigid supporter is not particularly limited, and as the rigid supporter, a known glass plate such as a soda glass plate including a silicon oxide film on a front surface, low expansion glass, non-alkali glass, and a quartz glass plate, a metal plate such as an aluminum plate, an iron plate, and an SUS plate, a resin plate, a ceramic plate, a slate, and the like are included. The flexible supporter is not particularly limited, and as the flexible supporter, cellulose ester (for example, cellulose acetate, cellulose propionate, and cellulose butyrate), a plastic film or paper such as a polyolefin (for example, a norbornene-based polymer), poly(meth)acrylic acid esters (for example, polymethyl methacrylate), a polycarbonate, a polyester (for example, polyethylene terephthalate or polyethylene naphthalate), and a polysulfone, an aluminum foil, fabric, and the like are included. From a viewpoint of easy handling, a film thickness of the rigid supporter is preferably 100 μm to 3000 μm, and is more preferably 300 μm to 1500 μm. A film thickness of the flexible supporter is preferably 3 μm to 500 μm, and is more preferably 10 μm to 200 μm.

[Production of Article Having Birefringent Pattern Using Roll-Like Supporter]

By using a roll-like plastic film or the like as the supporter, it is possible to efficiently produce the article having a film-like birefringent pattern on a large scale.

In addition, at this time, by using a roll-like polarization film as the polarization film affixed to the article having a birefringent pattern, it is possible to considerably improve efficiency of affixation by performing the affixation using a roll-to-roll method. In this case, the roll-like polarization film is usually prepared by setting a direction of the absorption axis of the polarization layer as a longitudinal direction, and thus it is preferable that the slow axis of the patterned optical anisotropic layer of the article having a birefringent pattern have an angle of 30 degrees to 60 degrees with respect to the longitudinal direction in order to improve visibility of the latent image.

In order to produce the article having a birefringent pattern, it is preferable that the alignment layer described in the production of the article, in particular, a layer of an organic compound (preferably, a polymer) which is subjected to a rubbing treatment be used. When the layer of the organic compound (preferably, the polymer) which is subjected to the rubbing treatment is used as the alignment layer, a rubbing direction thereof is suitably adjusted (for example, the rubbing direction is “oblique rubbing” having an angle of 30 degrees to 60 degrees with respect to the longitudinal direction), and thus it is possible to suitably adjust the direction of the slow axis of the patterned optical anisotropic layer.

By using the article having a birefringent pattern prepared as described above, it is possible to efficiently produce the article having a birefringent pattern in which the polarization film is affixed in a shape where an angle of the absorption axis of the polarization layer of the polarization film and the slow axis of the article having a birefringent pattern is 30 degrees to 60 degrees with respect to each other.

[Alignment Layer]

In order to form the optical anisotropic layer, the alignment layer may be used. The alignment layer is usually disposed on the supporter or a temporal supporter, or on an undercoat layer coated on the supporter or the temporal supporter. The alignment layer has a function for defining an aligning direction of the liquid crystalline compound which is disposed on the alignment layer. Any layer may be used as an alignment layer insofar as it is possible to impart an alignment property to the optical anisotropic layer. As a preferred example of the alignment layer, a layer of an organic compound (preferably, a polymer) which is subjected to a rubbing treatment, a light alignment layer exhibiting an alignment property of a liquid crystal by polarized light irradiation represented by an azobenzene polymer or polyvinyl cinnamate, an oblique vapor deposition layer of an inorganic compound, and a layer including a microgroove, in addition, a cumulative film of ω-tricosanoic acid, dioctadecyl methyl ammonium chloride, methyl stearate, or the like which is formed by a Langmuir-Blodgett method (an LB film), or a layer in which a dielectric body is aligned according to application of an electric field or a magnetic field are able to be included. As the alignment layer, a layer including polyvinyl alcohol in a rubbing state is preferable, and a layer which is able to be cross-linked with at least any one of an upper portion and a lower portion of the alignment layer is especially preferable. As a method of controlling the aligning direction, a light alignment layer and a microgroove are preferable. As the light alignment layer, a light alignment layer exhibiting an alignment property by being dimerized as polyvinyl cinnamate is especially preferable, and as the microgroove, an embossing treatment of a master roll which is prepared in advance by machine processing or laser processing is especially preferable.

[Reflective Layer]

It is preferable that the article having a birefringent pattern include a reflective layer such that the latent image is able to be visualized by the polarization film disposed on the front surface of the latent image. The reflective layer is not particularly limited, and as the reflective layer, for example, a layer in which reflective particles such as a pearl pigment are dispersed, or a cholesteric liquid crystal layer having a circular polarization selective reflection function, a reflective sheet disclosed in JP2009-126959A, and a reflective polarization separation sheet disclosed in U.S. Pat. No. 5,486,949A are included in addition to a metallic layer of aluminum, silver, or the like, and a dielectric multilayer film. A colored layer for adjusting a color, a polarization layer, and a scattering layer may be included between the reflective layer and the birefringent pattern layer. In addition, the reflective layer may be a semi-transmitting semi-reflective layer having transmissivity of 30% to 95%.

Metal used for a metallic thin film layer is not particularly limited, and as the metal, aluminum, chromium, nickel, silver, gold, and the like are included. The metallic thin film layer may be a single layer film or a multilayer film, and for example, is able to be manufactured by a vacuum film forming method, a physical vapor deposition method, a chemical vapor deposition method, and the like. As a layer including the reflective metallic particles, for example, a layer which is printed by an ink of gold, silver, or the like is included.

A dielectric thin film layer may be a single layer film or a multilayer film. As a material to be used, a thin film which is prepared by using a material having a refractive index which is considerably different from adjacent layers is preferable. As a high refractive index material, titanium oxide, zirconium oxide, zinc sulfide, indium oxide, and the like are included. As a low refractive index material, silicone dioxide, magnesium fluoride, calcium fluoride, aluminum fluoride, and the like are included.

It is preferable that the reflective layer be positioned on a side opposite to the patterned optical anisotropic layer when viewed from the polarization film side. In addition, instead of the reflective layer, a layer having reflectivity may be used as the supporter, or a front surface of the adherend may have reflectivity.

[Print Layer]

The article having a birefringent pattern may include a print layer in order to obtain a necessary visual effect. As the print layer, a layer having a pattern which is visible by visible light, ultraviolet light, infrared light, or the like formed thereon, and the like are included. A UV fluorescent ink or an IR ink itself is security printing, a security property is improved, and thus it is preferable. A method of forming the print layer is not particularly limited, and as the method, generally known letterpress printing, flexographic printing, gravure printing, offset printing, and screen printing, and further ink jet, xerography, and the like are able to be used. As the ink, various inks are able to be used, and a UV ink is preferably used from a viewpoint of durability. In addition, by using micro printing having a resolution greater than or equal to 1200 dpi, it is possible to increase a security property, and thus it is preferable.

[Release Layer]

In order to control a peeling property with respect to the polarization film, the article having a birefringent pattern may include a release layer on a side in contact with the polarization film.

As the release layer, a releasable resin, a resin containing a releasing agent, curable resin to be cross-linked by ionizing radiation, and the like are able to be applied. As the releasable resin, for example, a fluorine-based resin, silicone, a melamine-based resin, an epoxy resin, a polyester resin, acrylic-based resin, a cellulose-based resin, and the like are included, and the melamine-based resin is preferably included. As the resin containing the releasing agent, for example, a fluorine-based resin, silicone, an acrylic-based resin in which various releasing agents such as wax are added or copolymerized, a vinyl-based resin, a polyester resin, a cellulose-based resin, and the like are included.

The release layer may be formed by dispersing or dissolving the resin in a solvent, and by applying and drying the resin using a known coating method such as roll coat and a gravure coat. In addition, as necessary, the resin may be heated and dried at a temperature of 30° C. to 160° C., may be subjected to aging, or may be irradiated with ionizing radiation, and thus may be cross-linked. A thickness of the release layer is usually approximately 0.01 μm to 5.0 μm, and is preferably approximately 0.5 μm to 3.0 μm.

[Additional Adhesive Layer]

The article having a birefringent pattern may include an adhesive layer for being affixed to other articles. In this specification, the adhesive layer for being affixed to the other article is distinguished from the adhesive layer of the polarization film, and thus is referred to as an “additional adhesive layer”. By the additional adhesive layer, the article having a birefringent pattern is able to be provided in a shape where the article is able to be affixed to the other article. In this specification, such a shape is referred to as a “birefringent pattern label”. Similarly, in this specification, a shape where the polarization film is affixed to the birefringent pattern label is referred to as a “visualized birefringent pattern label” Obviously, both of the “birefringent pattern label” and the “visualized birefringent pattern label” are included in the article having a birefringent pattern, and the “visualized birefringent pattern label” is included in the visible latent image article.

When a peeling force between the additional adhesive layer of the birefringent pattern label and the other article is A (N/m), and a peeling force between the adhesive layer of the polarization film and the birefringent pattern label is B (N/m), it is preferable that a relationship of A>B be satisfied.

A material of the additional adhesive layer is not particularly limited, and as the material, a rubber-based adhesive agent, an acrylic-based adhesive agent, a silicone-based adhesive agent, a urethane-based adhesive agent, a vinyl alkyl ether-based adhesive agent, a polyvinyl alcohol-based adhesive agent, a polyvinyl pyrrolidone-based adhesive agent, a polyacrylamide-based adhesive agent, a cellulose-based adhesive agent, and the like are included. In addition, in order to improve a processing property, a laminated adhesive layer in which a film formed of an arbitrary material is interposed between two adhesive layers may be used instead of a single adhesive layer. As the film interposed between the two adhesive layers, cellulose ester, polyolefin, poly(meth)acrylic ester, a polyester, and the like are included.

A thickness of the additional adhesive layer is usually approximately 3 μm to 100 μm, is preferably 5 μm to 50 μm, and is more preferably 10 μm to 40 μm.

[Release Sheet]

As a shape suitable for the birefringent pattern label, the birefringent pattern label may include the release sheet adjacent to the additional adhesive layer. A peeling force between the release sheet and the additional adhesive layer may be 0.1 N/m to 100 N/m, is preferably 0.2 N/m to 80 N/m, and is more preferably 0.5 N/m to 50 N/m.

As a constituent material of the release sheet, a suitable thin leaf body such as paper, a synthetic resin film of a polyethylene, a polypropylene, polyethylene terephthalate, or the like, a rubber sheet, paper, fabric, non-woven fabric, a net, an expanded sheet, or a metallic foil, and a laminated body thereof is included. In order to increase a peeling property from the adhesive agent layer, as necessary, a front surface of the release sheet may be subjected to a low adhesiveness peeling treatment such as a silicone treatment, a long-chain alkyl treatment, and a fluorine treatment, or may be provided with a release layer. The release layer on the release sheet is not particularly limited, and as the release layer, the layers described above which are included as the release layer of the article having a birefringent pattern are are able to be used.

[Birefringent Pattern Label Integrated Body]

When the birefringent pattern label is provided, a shape in which the birefringent pattern label processed into a predetermined size is arranged on a series of release sheets into the shape of an island is also preferable. In this specification, such a shape is referred to as a “birefringent pattern label integrated body”. As a method of manufacturing the birefringent pattern label integrated body, so-called “extraction processing” in which a sheet-like or a roll-like article having a birefringent pattern is affixed to a laminated body of a sheet-like or a roll-like release sheet and the additional adhesive layer in a lamination order of the release sheet/the additional adhesive layer/the article having a birefringent pattern, then a cut is input into the article having a birefringent pattern and the additional adhesive layer in a predetermined shape, and the article having a birefringent pattern and the additional adhesive layer in an unnecessary portion is removed is preferably efficient.

[Visualized Birefringent Pattern Label Integrated Body]

Similar to the birefringent pattern label, the visualized birefringent pattern label may also include a release sheet adjacent to the additional adhesive layer. In addition, similarly, when the visualized birefringent pattern label is provided, a shape in which the visualized birefringent pattern label processed into a predetermined size is arranged on a series of release sheets into the shape of an island is also preferable. In this specification, such a shape is referred to as a “visualized birefringent pattern label integrated body”. In the visualized birefringent pattern label, when a peeling force between the adhesive layer of the polarization film and the birefringent pattern label is B (N/m), and a peeling force between the additional adhesive layer of the birefringent pattern label and the release sheet is C (N/m), a magnitude relationship between B and C is not particularly restricted, but a preferred magnitude relationship depends on a used shape or a manufacturing method.

[Case in which Birefringent Pattern Label and Polarization Film have Same Shape]

In the visualized birefringent pattern label integrated body, a case where the birefringent pattern label and the polarization film affixed on the birefringent pattern label have the same shape is considered. The same shape or an identical shape indicates that a shape of a surface indicating a front surface area on one surface of one film is same as that of the other film, and indicates that when the films overlap with each other, the shapes overlap with each other. In addition, more practically, the same shape or an identical shape indicates that when the films overlap with each other, there is no front surface portion of the birefringent pattern label which does not overlap with the polarization film. The shape has an advantage that the extraction processing of the birefringent pattern label and the extraction processing of the polarization film are able to be completed at one time. In this case, the polarization film and the birefringent pattern label fit into the same shape, and thus when the peeling force B between the adhesive layer of the polarization film and the birefringent pattern label is less than the peeling force C between the additional adhesive layer of the birefringent pattern label and the release sheet, there is a risk that only the polarization film is peeled off when the visualized birefringent pattern label is peeled from the release sheet and is affixed to the adherend. Accordingly, in this case, it is preferable that the peeling force B between the adhesive layer of the polarization film and the birefringent pattern label and the peeling force C between the additional adhesive layer of the birefringent pattern label and the release sheet satisfy a relationship of B>C.

[Case in which Polarization Film is Affixed to Only Part of Birefringent Pattern Label]

On the other hand, as described above, when it is necessary to perform the authenticity determination without peeling off the affixed polarization film (for example, when the authenticity determination is performed in the retail shop without peeling off the affixed polarization film, and then the customer tries to peel off the polarization film and perform the authenticity determination), it is preferable that the polarization film be affixed to only a part of the front surface of the birefringent pattern label. Here, unlike the above description, a case where the polarization film is affixed to only a part of the front surface of the birefringent pattern label in the visualized birefringent pattern label integrated body is considered. In this case, the polarization film and the birefringent pattern label have a different shape, and it is possible to peel off the polarization film by using a portion of the birefringent pattern label to which the polarization film is not affixed. For this reason, the risk that only the polarization film is peeled off is reduced, and there is no problem even when the peeling force B between the adhesive layer of the polarization film and the birefringent pattern label is less than the peeling force C between the additional adhesive layer of the birefringent pattern label and the release sheet in a step where the visualized birefringent pattern label is peeled off from the release sheet and is affixed to the adherend.

On the other hand, in this case, the polarization film and the birefringent pattern label have a different shape, and thus it is necessary that the extraction processing of the polarization film and the birefringent pattern label be separately performed. More specifically, the extraction processing of the birefringent pattern label is performed, then the polarization film is affixed to the entire surface of the birefringent pattern label, and then the extraction processing of the polarization film is performed. When the extraction processing of the polarization film is performed, obviously, it is necessary to remove the unnecessary portion of the polarization film, and at this time, the peeling force B (N/m) between the adhesive layer of the polarization film and the birefringent pattern label and the peeling force C (N/m) between the additional adhesive layer of the birefringent pattern label and the release sheet have the preferred magnitude relationship. That is, when the relationship of B>C is satisfied, a risk that each birefringent pattern label to which the unnecessary portion of the polarization film is affixed is also removed occurs when the unnecessary portion of the polarization film is removed. Accordingly, in this case, it is preferable that the peeling force B between the adhesive layer of the polarization film and the birefringent pattern label and the peeling force C between the additional adhesive layer of the birefringent pattern label and the release sheet satisfy a relationship of B≦C (in contrast with the case where the birefringent pattern label and the polarization film have the same shape).

[Article Affixed with Birefringent Pattern]

As an example of the article affixed with the birefringent pattern (or the adherend), paper (more specifically, for example, paper money, negotiable instrument of value, a makeup box, and the like), a plastic film, a plastic card, a glass product (for example, a bottle or the like), a metallic product (for example, an aluminum can or the like), and the like are included. Furthermore, as described above, the patterned optical anisotropic layer may be directly disposed on the adherend or may be disposed on the adherend through other functional layers or the like, and the patterned optical anisotropic layer disposed on the supporter may be affixed to the adherend through the adhesive layer or the like which is disposed on a side of the supporter opposite to the patterned optical anisotropic layer.

[Application of Article having Birefringent Pattern]

When the birefringent pattern on the front surface of the article having a birefringent pattern is not observed through the polarization film, the birefringent pattern is mostly colorless and transparent and is hardly visible, or only an image on the basis of the print layer and the like is visible, but when the birefringent pattern is observed through the polarization film, the birefringent pattern is able to be visually recognized such that additional characteristic contrast or color is easily exhibited. By using this property, the article having a birefringent pattern, for example, is able to be used as forgery prevention means. That is, the article having a birefringent pattern is affixed with the polarization film, and thus it is possible to identify a multicolor image. In the birefringent pattern, when the polarization film is peeled off, the image is not able to be identified. A preparing method of such a birefringent pattern is not widely known, and a material thereof is also special, and thus it is considered that the birefringent pattern is suitably used as the forgery prevention means.

The birefringent pattern of the front surface of the article having a birefringent pattern has a security effect due to the latent image, and for example, is able to be used in cooperation with digital information by encoding the pattern into a bar code and a QR code (registered trademark), and further is also able to be subjected to digital encryption. In addition, as described above, by forming a high resolution latent image, it is possible to print a micro latent image which is not recognized by the naked eye through a polarization plate, and it is possible to improve security. In addition, it is possible to improve security in combination with printing using an invisible ink such as a UV fluorescent ink and an IR ink.

The article having a birefringent pattern has not only security but also other functions, and for example, a display function of product information such as a price ticket or an expiration date, and a submergence detection function obtained by printing an ink of which a color is changed by water are able to be combined.

### Example

Hereinafter, the present invention will be described in more detail with reference to Examples. A material, a test agent, an amount of substance, and a proportion thereof, a manipulation, and the like described in the following Examples are able to be suitably changed without departing from the scope of the present invention. Accordingly, the range of the present invention is not limited to the following specific examples.

(Preparation of Coating Liquid for Alignment Layer AL-1)

The following compositions were prepared, were filtered by a polypropylene filter having a hole diameter of 30 μm, and thus were used as a coating liquid for an alignment layer AL-1

Composition of coating liquid for alignment layer (%)

| | |
|---|---|
| Polyvinyl alcohol (PVA205, manufactured by | 3.21 |
| Kuraray Co., Ltd.) | |
| Polyvinyl pyrrolidone (Luvitec K30, manufactured by | 1.48 |
| BASF Corporation) | |
| Distillated water | 52.10 |
| Methanol | 43.21 |

(Preparation of Coating Liquid for Optical Anisotropic Layer LC-1)

The following compositions were prepared, then were filtered by a polypropylene filter having a hole diameter of 0.1 μm, and thus were used as a coating liquid for an optical anisotropic layer LC-1.

LC-1-1 is a liquid crystal compound having two reactive groups, and one of the two reactive groups is an acryl group which is a radical reactive group, and the other is an oxetane group which is a cationic reactive group.

Composition of coating liquid for optical anisotropic layer (%)

| | |
|---|---|
| Polymerizable liquid crystal compound (LC-1-1) | 32.88 |
| Horizontal alignment agent (LC-1-2) | 0.05 |
| Cationic photopolymerization initiator (CP1100-P, manufactured | 0.66 |
| by San-Apro Ltd.) | |
| Polymerization control agent (IRGANOX1076, manufactured | 0.07 |
| by Ciba | |
| Specialty Chemicals Inc.) | |
| Methyl ethyl ketone | 46.34 |
| Cyclohexanone | 20.00 |

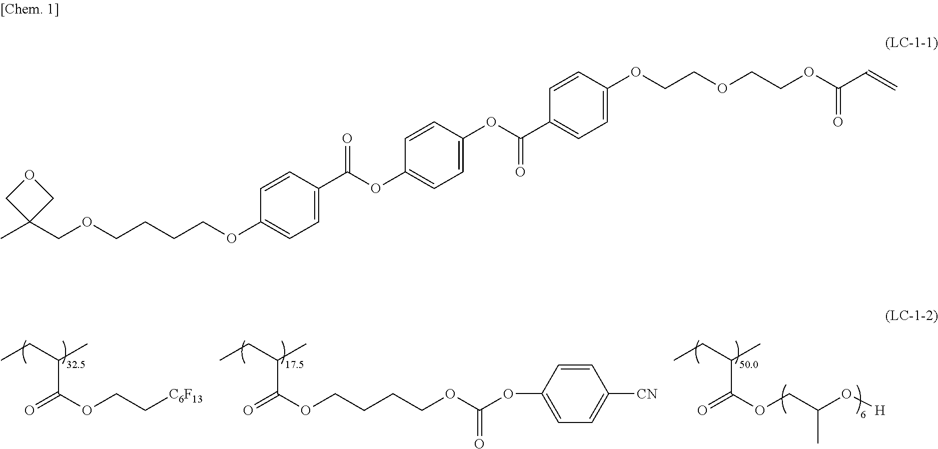

(Preparation of Additive Agent Layer OC-1)

The following compositions were prepared, then were filtered by a polypropylene filter having a hole diameter of 1.0 μm, and thus were used as a coating liquid for a transfer adhesive layer OC-1. As a radical photopolymerization initiator RPI-1, 2-trichloromethyl-5-(p-styrylstyryl)1,3,4-oxadiazole was used. The following composition is a used amount as a solution thereof.

Composition of coating liquid for additive agent layer (mass %)

| | |
|---|---|
| Binder (MH-101-5, manufactured by Fujikura Kasei Co., Ltd.) | 7.63 |
| Radical photopolymerization initiator (RPI-1) | 0.49 |
| Surfactant(Megafac F-176PF, manufactured by DIC Corporation) | 0.03 |
| Methyl ethyl ketone | 91.85 |

### Example 1

### Preparation of Birefringent Pattern Preparation Material P-1

Aluminum of 60 nm was deposited on a polyimide film (Kapton 200H, manufactured by Du Pont-Toray Co., Ltd.) having a thickness of 50 and thus a reflective layer attached supporter was prepared. The coating liquid for an alignment layer AL-1 was applied on a surface on which the aluminum was deposited by using a wire bar, and was dried. A thickness of the dried film was 0.5 μm. The alignment layer was subjected to a rubbing treatment, then the coating liquid for an optical anisotropic layer LC-1 was applied by using a wire bar, and was dried at a film surface temperature of 90° C. for 2 minutes to be in a liquid crystal phase state, then was irradiated with ultraviolet light by using a cooling metal halide lamp (manufactured by Eye Graphics Co., Ltd.) of 160 W/cm under atmosphere and an alignment state thereof was fixed, and thus an optical anisotropic layer having a thickness of 4.5 μm was formed. At this time, illuminance of the used ultraviolet light was 500 mW/cm² in a UV-A region (integration of a wavelength of 320 nm to 400 nm), and an irradiation amount was 500 mJ/cm² in the UV-A region. Retardation of the optical anisotropic layer was 400 nm, and the optical anisotropic layer was a solid polymer at 20° C. Finally, the coating liquid for an additive agent layer OC-1 was applied on the optical anisotropic layer and was dried, and an additive agent layer of 0.8 μm was formed, and thus a birefringent pattern preparation material M-1 of Example 1 was prepared.

### Example 2

### Article Having Birefringent Pattern

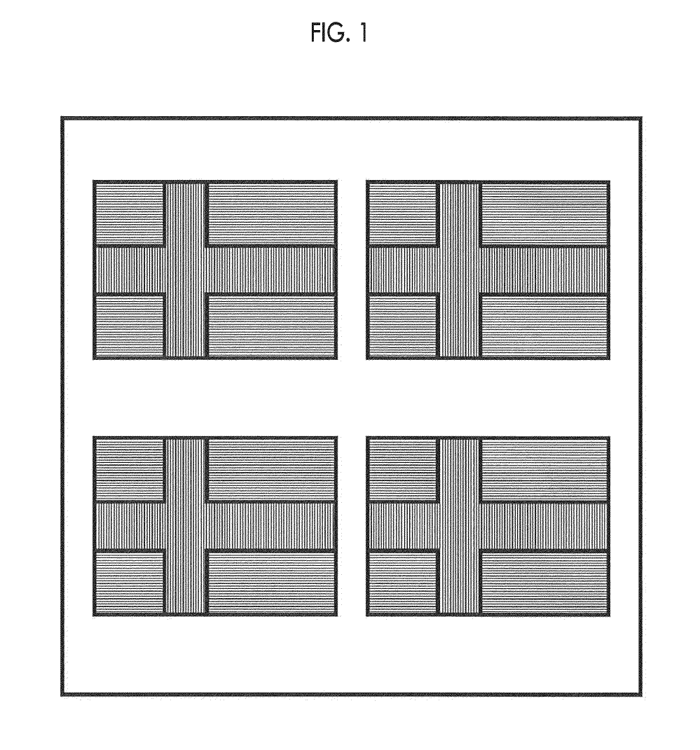

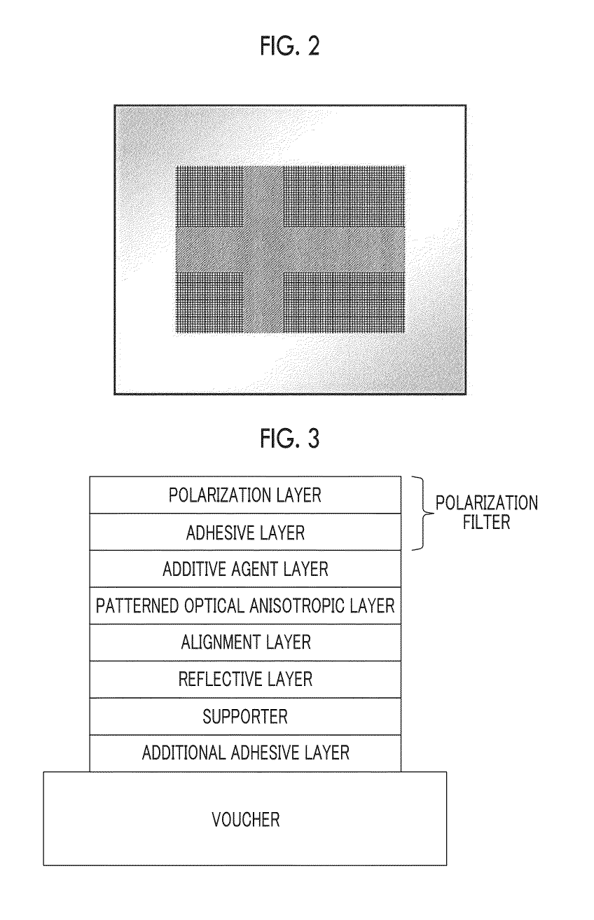

M-1 was subjected to pattern exposure into a pattern illustrated in FIG. 1 by using M-3L mask aligner manufactured by Mikasa Corporation and a photomask. In the drawing, M-1 was exposed such that an exposure amount of a region illustrated by a solid color was 0 mJ/cm², an exposure amount of a region illustrated by a horizontal line was 8 mJ/cm², and an exposure amount of a region illustrated by a vertical line was 25 mJ/cm². Then, M-1 was heated in a clean oven at 210° C. for 30 minutes, and thus an article having a birefringent pattern M-2 was prepared. A polarization filter was disposed on the article M-2, then when the polarization filter was disposed in a predetermined direction, the birefringent pattern formed on the article having a birefringent pattern M-2 was able to be confirmed. An enlarged diagram of the pattern observed through the polarization plate on the article having a birefringent pattern M-2 is illustrated in FIG. 2. In the drawing, a two-color pattern in which the aluminum on a ground exhibits a silver color, whereas a lattice portion exhibits a mazarine color to an aqua color, and a slanted portion exhibits a yellow color or an orange color is observed.

### Example 3

### Preparation of Visualized Birefringent Pattern Label

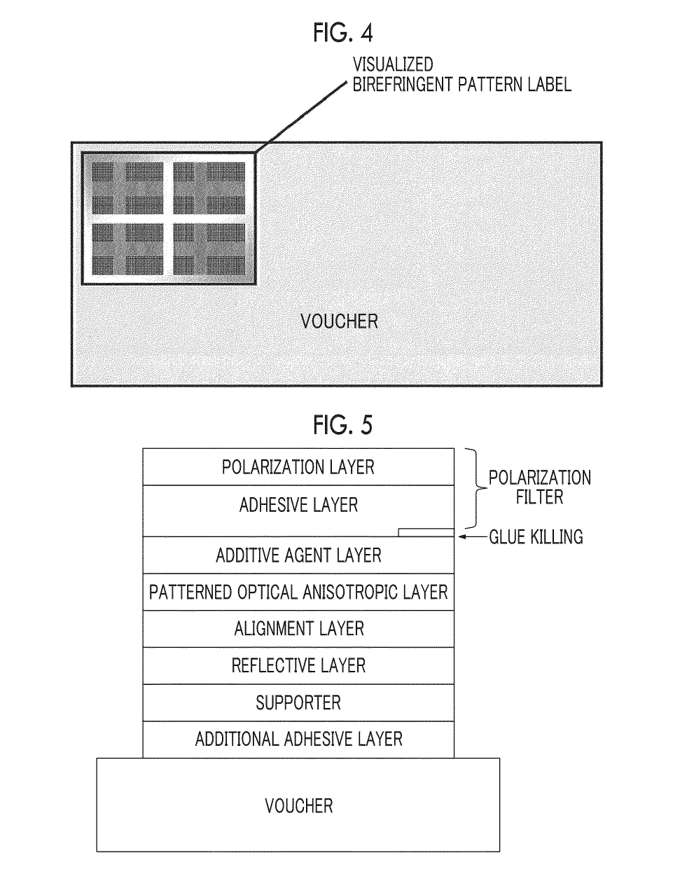

A release sheet attached with an adhesive agent was affixed to a back surface (the polyimide film side) of the article having a birefringent pattern M-2, and an additional adhesive layer was formed, then a polarization filter P-1 having a thickness of 210 μm and a tensile modulus of elasticity of 5.5 GPa was affixed to a front surface (a side from which the pattern was observed), was cut into a suitable size, and thus a visualized birefringent pattern label PL-1 was prepared. At this time, a peeling force of the polarization filter P-1 from the visualized birefringent pattern label PL-1 measured by using a 180° peeling method was 300 N/m. An example in which the visualized birefringent pattern label PL-1 was peeled off from the release sheet and was affixed to a voucher is illustrated in FIG. 3 and FIG. 4. In FIG. 4, an upper-left portion of the voucher is an attachment portion of the visualized birefringent pattern label. The birefringent pattern of the visualized birefringent pattern label is able to be usually visually observed as the two-color pattern, but when the polarization filter affixed to the front surface is peeled off, the pattern is invisible, and according to this change, the authenticity determination is able to be performed.

### Example 4

### Physical Property Preferable for Polarization Filter

In Example 3, instead of P-1, polarization filters P-2 to P-5 shown in Table 1 were affixed as the polarization filter, and thus visualized birefringent pattern labels PL-2 to PL-5 were prepared.

TABLE 1

| | | Physical Property of Polarization Filter | |
|---|---|---|---|
| | | | Tensile Modulus of |
| Test Agent | Polarization Filter | Thickness (μm) | Elasticity (GPa) |
| PL-2 | P-2 | 210 | 5.5 |
| PL-3 | P-3 | 130 | 4.6 |
| PL-4 | P-4 | 400 | 6.0 |
| PL-5 | P-5 | 210 | 10.0 |

The prepared visualized birefringent pattern labels PL-2 to PL-5 were affixed to a cylindrical article having a diameter of 10 mm, then PL-2 and PL-3 were affixed without any problem, and the labels PL-4 and PL-5 were affixed, but the polarization filter was not peeled off along a curved surface, and thus did not suitably function.

### Example 5

### Example Using Polarization Filter Subjected to Glue Killing

In Example 3, instead of P-1, a polarization filter P-6 in which a part of the adhesive layer was subjected to glue killing using varnish was affixed as the polarization filter, and thus a visualized birefringent pattern label PL-6 was prepared. An example in which the visualized birefringent pattern label PL-6 was peeled off from the release sheet and was affixed to the voucher is illustrated in FIG. 5. In the visualized birefringent pattern label PL-6, adhesiveness of the polarization filter of the portion subjected to the glue killing decreases, and thus the polarization filter is easily peeled off, and the authenticity determination is able to be more smoothly performed.

### Example 6

### Example in which Polarization Filter is Affixed to Only Part and in-Process Inspection is Able to be Performed

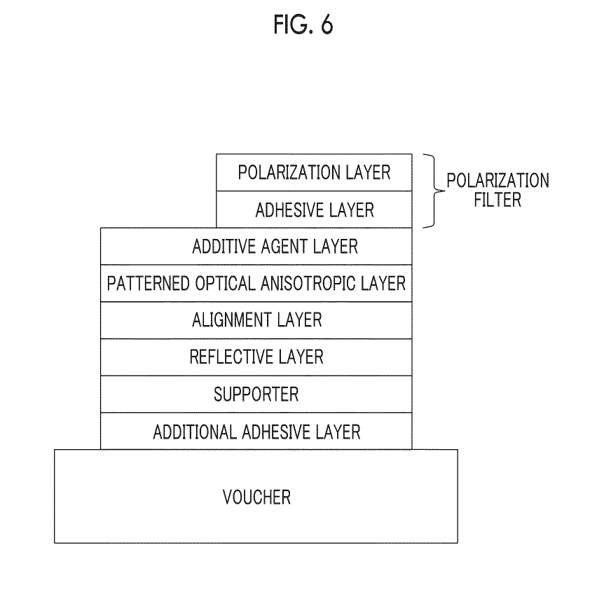

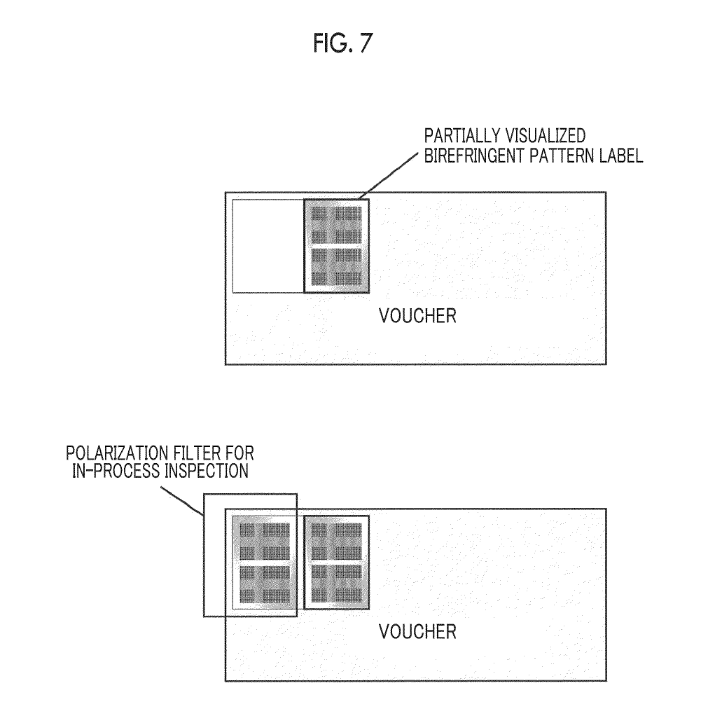

In Example 3, instead of P-1, a polarization filter P-7 which was slightly small was affixed as the polarization filter, and thus a partially visualized birefringent pattern label PL-7 was prepared. An example in which the partially visualized birefringent pattern label PL-7 was peeled off from the release sheet and was affixed to the voucher is illustrated in FIG. 6 and FIG. 7. The prepared partially visualized birefringent pattern label PL-7 includes a portion which is able to be usually visually observed as the two-color pattern, and includes a portion which is able to be visually observed by disposing the polarization filter on a part which is usually invisible, and thus it is possible to perform the in-process inspection by disposing another polarization filter while having a function of performing the authenticity determination by peeling off the affixed polarization filter.

### Example 7

### Example Excellent in Peeling Property of Polarization Filter Including Release Layer

(Preparation of Releasing Coating Liquid FL-1)

The following compositions were prepared, and thus were used as a coating liquid for a release layer FL-1.

Composition of coating liquid for release layer (%)

| | |
|---|---|
| Silicone-based polymer solution (KS-847T, manufactured | 8.25 |
| by Shin-Etsu Chemical Co , Ltd.) | |
| Curing agent solution (CAT-PL-50, manufactured by | 0.08 |
| Shin-Etsu Chemical Co., Ltd.) | |
| Methyl ethyl ketone | 91.67 |

The coating liquid for a release layer FL-1 was coated on the front surface (the side from which the pattern was observed) of the article having a birefringent pattern M-2 prepared in Example 3 and was dried, and thus a release layer of 0.5 μm was formed. The release sheet attached with the adhesive agent was affixed to the back surface (the polyimide film side) of the article having a birefringent pattern on which the release layer was formed, and the additional adhesive layer was formed, then a polarization filter P-8 having a thickness of 130 μm and a tensile modulus of elasticity of 4.6 GPa was affixed to the front surface (the side from which the pattern was observed), then was cut into a suitable size, and thus a visualized birefringent pattern label PL-8 was prepared. At this time, a peeling force of the polarization filter P-8 from the visualized birefringent pattern label PL-8 measured by using a 180° peeling method was 6.0 N/m. In the visualized birefringent pattern label PL-8, the polarization filter is easily peeled off by forming the release layer, and the authenticity determination is able to be more smoothly performed.

### Example 8

### Example in which Birefringent Pattern Label is Translucent

Aluminum was deposited on a polyethylene naphthalate film (Teonex Q83, manufactured by Teijin DuPont Films Japan Limited) having a thickness of 50 μm, and thus a semitransmitting semireflective layer-attached supporter having transmissivity of 35% and reflectance of 54% was prepared. The coating liquid for an alignment layer AL-1 was applied on a surface on which the aluminum was deposited by using a wire bar, and was dried. A thickness of the dried film was 0.5 μm. The alignment layer was subjected to a rubbing treatment, then the coating liquid for an optical anisotropic layer LC-1 was applied by using a wire bar, and was dried at a film surface temperature of 90° C. for 2 minutes to be in a liquid crystal phase state, then was irradiated with ultraviolet light by using a cooling metal halide lamp (manufactured by Eye Graphics Co., Ltd.) of 160 W/cm under atmosphere and an alignment state thereof was fixed, and thus an optical anisotropic layer having a thickness of 1.5 μm was formed. At this time, illuminance of the used ultraviolet light was 1000 mW/cm² in a UV-A region (integration of a wavelength of 320 nm to 400 nm), and an irradiation amount was 800 mJ/cm² in the UV-A region. Retardation of the optical anisotropic layer was 400 nm, and the optical anisotropic layer was a solid polymer at 20° C. Finally, the coating liquid for an additive agent layer 0C-1 was applied on the optical anisotropic layer and was dried, and an additive agent layer of 0.8 μm was formed, and thus a birefringent pattern preparation material M-3 of Example 8 was prepared.

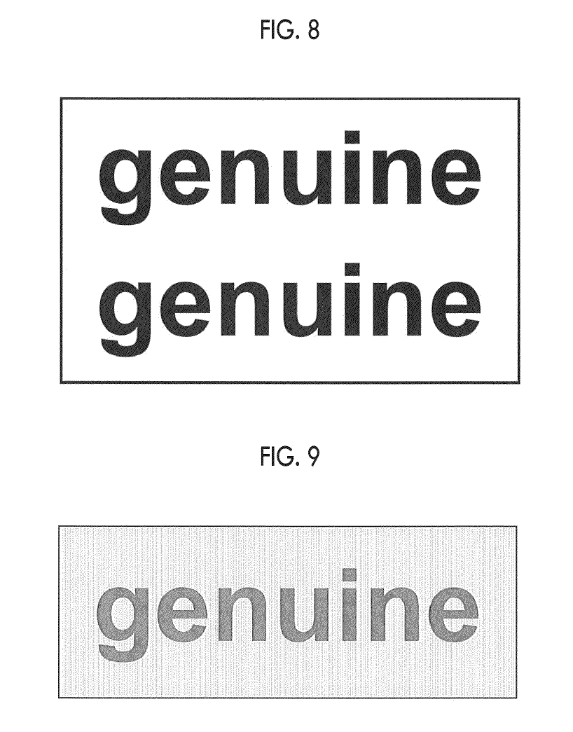

M-3 was subjected to pattern exposure into a pattern illustrated in FIG. 8 by using a mask aligner M-3L manufactured by Mikasa Corporation and a photomask. M-3 was exposed such that an exposure amount of a region illustrated by a solid color in the drawing was 0 mJ/cm², and an exposure amount of a character portion was 100 mJ/cm². Then, M-3 was heated in a clean oven at 200° C. for 30 minutes, and thus a semi-transmitting article having a birefringent pattern M-4 was prepared. When a polarization filter was disposed on the semi-transmitting article having a birefringent pattern M-4 in a predetermined direction, the birefringent pattern formed on the semi-transmitting article having a birefringent pattern M-4 was able to be confirmed. An enlarged diagram of the pattern observed through the polarization plate on the semi-transmitting article having a birefringent pattern M-4 is illustrated in FIG. 9. In the prepared pattern, a ground is observed as a translucent gray color, whereas the character portion is observed as a light blue color.

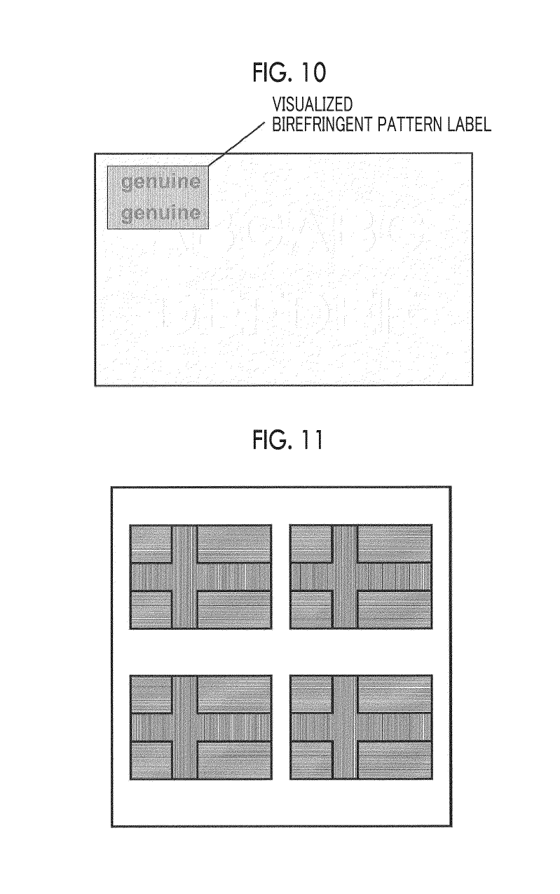

A release sheet attached with an adhesive agent was affixed to a back surface (a PEN film side) of the semi-transmitting article having a birefringent pattern M-4, and an additional adhesive layer was formed, then a polarization filter P-9 having a thickness of 130 μm and a tensile modulus of elasticity of 4.6 GPa was affixed to a front surface (a side from which the pattern was observed), then was cut into a suitable size, and thus a visualized semi-transmitting birefringent pattern label PL-9 was prepared. An example in which the visualized semi-transmitting birefringent pattern label PL-9 was peeled off from the release sheet, and was affixed to a plastic card of which a ground is subjected to printing is illustrated in FIG. 10. In FIG. 10, an upper-left portion of the card is an attachment portion of the visualized semi-transmitting birefringent pattern label. The birefringent pattern of the visualized semi-transmitting birefringent pattern label is able to be visually observed as a pattern, but when the polarization filter affixed to the front surface is peeled off, the pattern is invisible, and according to this change, the authenticity determination is able to be performed. In addition, the visualized semi-transmitting birefringent pattern label PL-9 is translucent, and thus it is possible to observe the printing of the ground through a pattern portion.

### Example 9

### Example of Roll-Like Article Having Birefringent Pattern

Aluminum of 60 nm was deposited on a polyimide film (Kapton 200H, manufactured by Du Pont-Toray Co., Ltd.) having a thickness of 50 μm, and thus a reflective layer attached supporter was prepared. The coating liquid for an alignment layer AL-1 was applied on a surface on which the aluminum was deposited by using a wire bar, and was dried. A thickness of the dried film was 0.5 μm. The alignment layer was subjected to an oblique rubbing treatment, then the coating liquid for an optical anisotropic layer LC-1 was applied by using a wire bar, and was dried at a film surface temperature of 90° C. for 2 minutes to be in a liquid crystal phase state, then was irradiated with ultraviolet light by using a cooling metal halide lamp (manufactured by Eye Graphics Co., Ltd.) of 160 W/cm under atmosphere and an alignment state thereof was fixed, and thus an optical anisotropic layer having a thickness of 4.5 μm was formed. At this time, illuminance of the used ultraviolet light was 500 mW/cm² in a UV-A region (integration of a wavelength of 320 nm to 400 nm), and an irradiation amount was 500 mJ/cm² in the UV-A region. Retardation of the optical anisotropic layer was 400 nm, and the optical anisotropic layer was a solid polymer at 20° C. In addition, a slow axis of the optical anisotropic layer was in a direction of 45° with respect to a transporting direction of the roll. Finally, the coating liquid for an additive agent layer OC-1 was coated on the optical anisotropic layer and was dried, and an additive agent layer of 0.8 μm was formed, and thus a birefringent pattern preparation material roll M-5 of Example 9 was prepared.

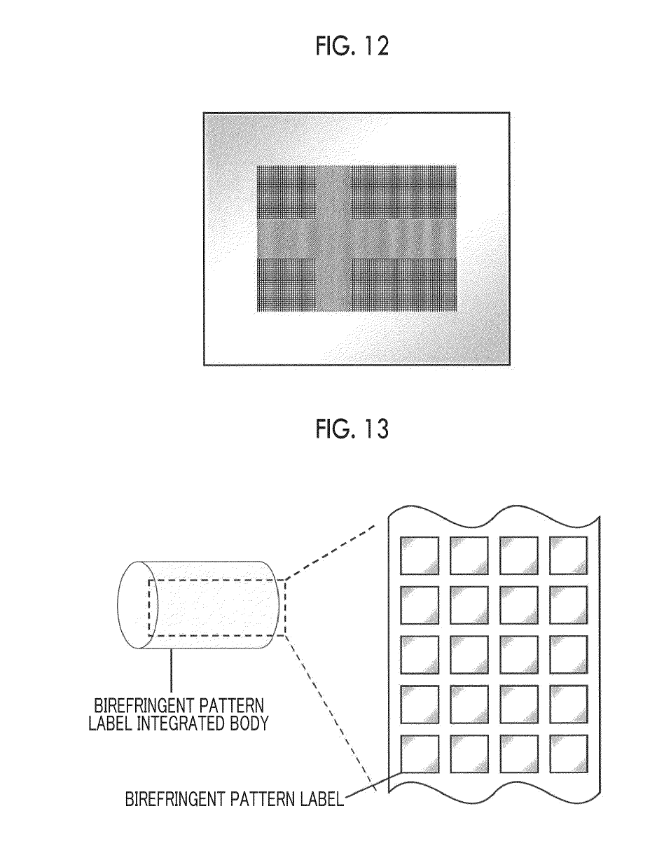

M-5 was subjected to pattern exposure into a pattern illustrated in FIG. 11 by using a digital exposing device (INPREX IP-3600H, manufactured by FUJIFILM Corporation) of laser scanning exposure. In the drawing, M-5 was exposed such that an exposure amount of a region illustrated by a solid color was 0 mJ/cm², an exposure amount of a region illustrated by a horizontal line was 15 mJ/cm², and an exposure amount of a region illustrated by a vertical line was 30 mJ/cm². Then, M-5 was heated in a far infrared heater continuous furnace by R to R at a film surface temperature of 210° C. for 15 minutes, and thus a roll-like article having a birefringent pattern M-6 was prepared. A polarization filter was disposed on the roll-like article having a birefringent pattern M-6, then when the polarization filter was disposed in a predetermined direction, the birefringent pattern formed on the roll-like article having a birefringent pattern M-6 was able to be confirmed. An enlarged diagram of the pattern observed through the polarization plate on the roll-like article having a birefringent pattern M-6 is illustrated in FIG. 12. In the drawing, a two-color pattern in which the aluminum on a ground exhibits a silver color, whereas a lattice portion exhibits a mazarine color to an aqua color, and a slanted portion exhibits a yellow color or an orange color is observed.

### Example 10

### Example of Visualized Birefringent Pattern Label Integrated Body in which Polarization Film is Affixed to Only Part of Birefringent Pattern Label

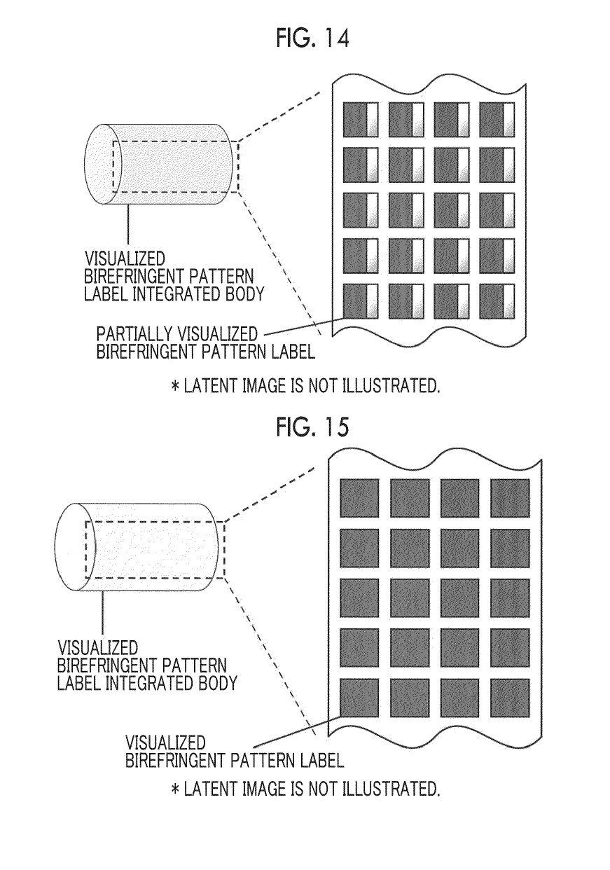

The coating liquid for a release layer FL-1 was applied on a front surface (a side from which the pattern is observed) of the roll-like article having a birefringent pattern M-6 and was dried, and thus a release layer of 0.5 μm was formed. A release sheet attached with an adhesive agent was affixed to a back surface (the polyimide film side) of the roll-like article having a birefringent pattern M-6 on which the release layer is formed, and an additional adhesive layer was formed, the additional adhesive layer was subjected to extraction processing into a desired shape, and thus a birefringent pattern label integrated body M-7 discretely including labels on a release sheet was prepared (FIG. 13). At this time, a peeling force of the birefringent pattern label from the release sheet measured by using a 180° peeling method was 50 N/m. A polarization filter roll P-10 having a thickness of 210 μm, a tensile modulus of elasticity of 5.5 GPa, and an absorption axis in the transporting direction was affixed to a front surface (a side from which the pattern was observed) of the birefringent pattern label roll M-7, and the polarization filter was subjected to the extraction processing into a desired shape, and thus a visualized birefringent pattern label integrated body PL-10 was prepared (FIG. 14). At this time, a peeling force of the polarization filter from the birefringent pattern label measured by using a 180° peeling method was 6.0 N/m. The visualized birefringent pattern label on the release sheet was taken out from the visualized birefringent pattern label integrated body PL-10 by a hand operation or a machine operation, and thus was able to be affixed to a desired adherend. As described in this Example, by using the manufacturing method of the present invention, it is possible to produce a desired visualized birefringent pattern label on a large scale.

### Example 11

### Example of Visualized Birefringent Pattern Label Integrated Body in which Birefringent Pattern Label and Polarization Film have Same Shape

A release sheet attached with an adhesive agent was affixed to a back surface (the polyimide film side) of the roll-like article having a birefringent pattern M-6, and an additional adhesive layer was formed, and thus a roll-like article M-8 having a visualized birefringent pattern was prepared. At this time, a peeling force of the birefringent pattern label from the release sheet measured by using a 180° peeling method was 50 N/m. A polarization filter roll P-10 having a thickness of 210 μm, a tensile modulus of elasticity of 5.5 GPa, and an absorption axis in the transporting direction was affixed to a front surface (a side from which the pattern was observed) of the roll-like article having a visualized birefringent pattern M-8, the article having a birefringent pattern and the polarization filter were subjected to the extraction processing into a desired shape, and thus a visualized birefringent pattern label roll PL-11 was prepared (FIG. 15). At this time, a peeling force of the polarization filter from the birefringent pattern label measured by using a 180° peeling method was 300 N/m. The visualized birefringent pattern label on the release sheet was taken out from the birefringent pattern label roll PL-10 by a hand operation or a machine operation, and thus was able to be affixed to a desired adherend. As described in this Example, when the birefringent pattern label and the polarization filter have the same shape, both of the birefringent pattern label and the polarization filter are affixed, and then are subjected to the extraction processing, and thus it is possible to reduce the number of times of the extraction processing and to reduce the cost.

What is claimed is:

1. A polarization film which is peelably affixed to an article having a birefringent pattern and visualizes a latent image due to the birefringent pattern, the polarization film comprising:
a polarization layer transmitting a specific linear polarization component, a circular polarization component, or an elliptical polarization component; and
an adhesive layer,
wherein a tensile modulus of elasticity E of the polarization film is 0.01 GPa to 7.8 GPa, and
a thickness h of the polarization film is 60 μm to 300 μm.

2. The polarization film according to claim 1,
wherein the adhesive layer is disposed such that the adhesive layer is not able to be adhered to the article having a birefringent pattern in at least a part of a region in contact with an outer circumference of a polarization filter.

3. A visible latent image article, comprising:
the polarization film and the article having a birefringent pattern according to claim 1,
wherein the polarization film is peelably affixed to the article having a birefringent pattern through the adhesive layer, and thus a latent image due to the birefringent pattern is visible by the polarization film.

4. A visible latent image article, comprising:
the polarization film and the article having a birefringent pattern according to claim 2,
wherein the polarization film is peelably affixed to the article having a birefringent pattern through the adhesive layer, and thus a latent image due to the birefringent pattern is visible by the polarization film.

5. The visible latent image article according to claim 3,
wherein a peeling force A between the polarization film and the article having a birefringent pattern is 1.0 N/m to 500 N/m.

6. The visible latent image article according to claim 4,
wherein a peeling force A between the polarization film and the article having a birefringent pattern is 1.0 N/m to 500 N/m.

7. The visible latent image article according to claim 5,
wherein an elastic modulus E and a thickness h of the polarization film, and the peeling force A have the following relationship:
h³E/2.6<100×A.

8. The visible latent image article according to claim 6,
wherein an elastic modulus E and a thickness h of the polarization film, and the peeling force A have the following relationship:
h³E/2.6<100×A.

9. The visible latent image article according to claim 3,
wherein the article having a birefringent pattern includes an additional adhesive layer on a side opposite to a surface in contact with the polarization film.

10. The visible latent image article according to claim 4,
wherein the article having a birefringent pattern includes an additional adhesive layer on a side opposite to a surface in contact with the polarization film.

11. The visible latent image article according to claim 5,
wherein the article having a birefringent pattern includes an additional adhesive layer on a side opposite to a surface in contact with the polarization film.

12. The visible latent image article according to claim 6,
wherein the article having a birefringent pattern includes an additional adhesive layer on a side opposite to a surface in contact with the polarization film.

13. The visible latent image article according to claim 7,
wherein the article having a birefringent pattern includes an additional adhesive layer on a side opposite to a surface in contact with the polarization film.

14. The visible latent image article according to claim 8,
wherein the article having a birefringent pattern includes an additional adhesive layer on a side opposite to a surface in contact with the polarization film.

15. The visible latent image article according to claim 9,
wherein a release sheet is disposed on a side opposite to the polarization film on the basis of the additional adhesive layer.

16. The visible latent image article according to claim 15,
wherein a shape of the polarization film and a shape of the article having a birefringent pattern are approximately identical to each other, and when a peeling force between the polarization film and the article having a birefringent pattern is B (N/m), and a peeling force between the article having a birefringent pattern and the release sheet is C (N/m), B>C is satisfied.

17. The visible latent image article according to claim 15,
wherein the polarization film is affixed to only a part of a visible side front surface of the article having a birefringent pattern, and when a peeling force between the polarization film and the article having a birefringent pattern is B (N/m), and a peeling force between the article having a birefringent pattern and the release sheet is C (N/m), B≦C is satisfied.

18. The visible latent image article according to claim 3,
wherein the polarization layer is a polarization layer transmitting a linear polarization component or an elliptical polarization component, and an angle between a maximum absorption axis of the polarization layer and a slow axis of a region of at least a part of the article having a birefringent pattern is 30 degrees to 60 degrees.

19. The visible latent image article according to claim 3,
wherein the article having a birefringent pattern includes a patterned optical anisotropic layer formed of a composition including a liquid crystalline compound.

20. A manufacturing method of the visible latent image article according to claim 19, comprising:
rubbing an alignment layer on a roll-like supporter in a direction having an angle of 30 degrees to 60 degrees with respect to a longitudinal direction of the supporter;
obtaining a roll-like laminated body by forming the patterned optical anisotropic layer on the rubbed alignment layer; and
affixing the polarization film which is wound in the shape of a roll having a direction of an absorption axis of the laminated body and the polarization layer as a longitudinal direction by roll-to-roll processing.
